(19) United States
(12) Patent Application Publication
(10) Pub. No.: US 2008/0306783 A1
(43) Pub. Date: Dec. 11, 2008

(54) Modeling a supply chain

(75) Inventors: Shang-Tae Yee, Troy, MI (US); Jeffrey D. Tew, Rochester, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/758,056

(22) Filed: Jun. 5, 2007

(51) Int. Cl. G06F 9/44

(52) U.S. Cl. 705/7

(57) ABSTRACT

A method, system, and computer program product for modeling a supply chain. The method includes modeling a storage element in the supply chain as a place node and modeling an activity in the supply chain as a transition node. The transition node includes at least one of an immediate transition node, a timed transition node, and a substitution transition node. An item moved through the supply chain is modeled as a token, where the token includes multiple attributes associated with the item. The place node is linked to the transition node with a directed arc, with the directed arc indicating the direction of token movement between the place node and the transition node. The linked place and transition nodes are organized as a supply chain model that represents the flow of items through the supply chain. In addition, performance metrics for the supply chain model are defined.

### BACKGROUND OF THE INVENTION

The present disclosure relates generally to supply chains, and more specifically to modeling a supply chain.

A typical supply chain includes numerous parties that have complex operational characteristics. In addition, there are interactions between supply chain members for sharing information. For example, after having received customer orders, a manufacturer may respond by placing orders to suppliers for the materials required to produce the ordered products. Communications and interactions are needed to order and receive the materials in a given time window. Simulation is a useful tool in emulating operations of different business environments, in particular, for modeling and analyzing behavior that is not easily modeled using analytical methods. A simulation tool may assist executives, contract managers, and logistics specialists in performing a variety of tasks, such as predicting system performance, optimizing resource utilization, and testing business scenarios. While there are some general-purpose simulation tools available in the market, such simulation tools are generally too limited to accurately model the sophisticated operational details of supply chains.

A supply chain can involve multiple supply chain members collaborating to produce a large number of customized products, such as an automotive supply chain. Such a supply chain is difficult to model accurately due to complicated mutual interactions among supply chain members. Difficulties in modeling supply chains include handling multiple attributes associated with items, e.g., products and materials, within the supply chain and multiple levels of hierarchy, particularly when there are several members involved in the supply chain. For example, an automotive supply chain is multi-attribute because it needs to handle a large set of vehicle types and configurations, adding further complexity to a simulation model. An automotive supply chain is also hierarchical because a member's operations can be hierarchically decomposed into sub-operations, resulting in a supply chain model with both breadth and depth. Existing simulation and modeling tools fail to address the need to develop supply chain models that support multiple attributes and multiple levels of hierarchy for accurate simulation.

Accordingly, there is a need in the art for a method for hierarchical and multi-attribute modeling of a supply chain.

### BRIEF DESCRIPTION OF THE INVENTION

An embodiment of the invention includes a method for modeling a supply chain. The method includes modeling a storage element in the supply chain as a place node and modeling an activity in the supply chain as a transition node. The transition node includes at least one of an immediate transition node, a timed transition node, and a substitution transition node. An item moved through the supply chain is modeled as a token, where the token includes multiple attributes associated with the item. The place node is linked to the transition node with a directed arc, with the directed arc indicating the direction of token movement between the place node and the transition node. The linked place and transition nodes are organized as a supply chain model that represents the flow of items through the supply chain. In addition, performance metrics for the supply chain model are defined.

Another embodiment of the invention includes a system for modeling a supply chain. The system includes a storage device for storing a supply chain model and a host system with a processing circuit responsive to executable instructions which, when executed by the processing circuit facilitates modeling a storage element in the supply chain as a place node, and modeling an activity in the supply chain as a transition node. The transition node includes at least one of an immediate transition node, a timed transition node, and a substitution transition node. In addition, the processing circuit facilitates modeling an item moved through the supply chain as a token, where the token includes multiple attributes associated with the item. The place node is linked to the transition node with a directed arc, with the directed arc indicating the direction of token movement between the place node and the transition node. The processing circuit further facilitates organizing the linked place and transition nodes as a supply chain model that represents the flow of items through the supply chain. In addition, the processing circuit facilitates defining performance metrics for the supply chain model.

A further embodiment of the invention includes a computer program product for modeling a supply chain. The computer program product includes a storage medium readable by a processing circuit and storing instructions for execution by the processing circuit for performing a method. The method includes modeling a storage element in the supply chain as a place node and modeling an activity in the supply chain as a transition node. The transition node includes at least one of an immediate transition node, a timed transition node, and a substitution transition node. An item moved through the supply chain is modeled as a token, where the token includes multiple attributes associated with the item. The place node is linked to the transition node with a directed arc, with the directed arc indicating the direction of token movement between the place node and the transition node. The linked place and transition nodes are organized as a supply chain model that represents the flow of items through the supply chain. In addition, performance metrics for the supply chain model are defined.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring to the exemplary drawings wherein like elements are numbered alike in the accompanying Figures:

FIG. 1 depicts an exemplary system for modeling a supply chain that may be utilized by exemplary embodiments;

FIG. 2 depicts an exemplary process flow that may be implemented by exemplary embodiments to model a supply chain;

FIG. 3 depicts an exemplary supply chain model for an automotive manufacturing supply chain;

FIG. 4 depicts an exemplary supply chain sub-model for a dealer in the automotive manufacturing supply chain model of FIG. 3; and

FIG. 5 depicts an exemplary supply chain sub-model for a plant in the automotive manufacturing supply chain model of FIG. 3.

### DETAILED DESCRIPTION OF THE INVENTION

Exemplary embodiments, as shown and described by the various figures and the accompanying text, provide methods, systems and computer program products for hierarchical and multi-attribute modeling of a supply chain. The modeling and simulation of complex business operations in a supply chain using a multi-attribute and hierarchical approach is further described herein. A Petri net (PN), also known as a place/transition net, provides a mathematical and graphical basis for representing a structure of a distributed system. A PN typically includes place nodes, transition nodes, and directed arcs. These PN elements are also referred to more simply as places, transitions, and arcs. Exemplary embodiments utilize and extend PNs to perform the processing described herein.

A place node acts as a storage element (e.g., a buffer) and may contain any number of tokens. A place node may also maintain a token sequence, such as a first-in-first-out (FIFO) buffer (e.g., a conveyor belt). A place node is connected to a transition node by a directed arc. A place node connected by a directed arc into a transition node is referred to as an input place of the transition. A place node connected by a directed arc out of a transition node is referred to as an output place of the transition.

A transition node models system activity and acts on an input token by a process known as firing. A transition node is enabled if it can fire, i.e., there is a token in an input place of the transition and any guarding logic is satisfied. Guarding logic or a guarding function can prevent a transition node from firing until a defined condition is satisfied. In exemplary embodiments, once enabled, a transition node can transition immediately or after a time delay. Alternatively, a transition node may be a substitution transition node. A substitution transition node acts as a placeholder for a subnet or sub-model that may include place nodes, transition nodes, and connecting arcs.

When a transition node fires, it consumes tokens from its input places, performs a processing task, and passes a specified number of tokens into its output places. Token movement between a place node and a transition node may involve creating a new token, transferring or copying an existing token, or setting a token attribute. Multiple transition nodes can be enabled at any given time, allowing contemporaneous firings within the PN. Transition firing is nondeterministic, which enables modeling of concurrent behavior of a distributed system, such as a supply chain. Transition nodes that fire contemporaneously may use a priority scheme to control the order of operations within the PN.

Complex business models usually contain many replications of similar structures, such as dealers and plants, which can be modeled using a hierarchical and modular approach. A supply chain model may be decomposed into smaller sub-models, including both a horizontal and a vertical structure. Each sub-model may represent operations performed by a business entity, such as a manufacturing plant. After developing each sub-model, a complete supply chain model can be formed by integrating all of the sub-models. The ability to generate smaller sub-models and integrate them provides a modeling process that enables the construction of a large, complex PN model of the complete supply chain.

The modeling process can be realized at many levels of abstraction, both horizontally and vertically. Horizontal structures represent relationships between separate business entities or business units, while vertical structures provide greater levels of detail for horizontal model elements. For example, a manufacturing plant portion of a supply chain can be modeled as a PN, which may include multiple places and transitions connected by arcs. The manufacturing plant can be modularized as a sub-model or PN sub-net, enabling the manufacturing plant to appear as a single transition node in a higher-level PN model of the complete supply chain. Using this approach, sub-models of a process can be regarded as PN sub-nets of a larger PN. Because partitioning a PN into several sub-nets does not change the structural properties of the PN, there is significant flexibility and simplicity in model construction.

In exemplary embodiments, each customer order in a supply chain model is tracked from order creation, through manufacturing and logistics, to delivery to the customer. To produce a robust supply chain model, the model accounts for variability in configuration and customization options for each order. For example, in an automotive supply chain, a dealer may sell a variety of vehicle models, and each vehicle model may include numerous options, such as side airbags or leather trim. There may be thousands of combinations and permutations of order configuration variations supported by the supply chain model. To support a high degree of flexibility in such a supply chain, the supply chain model may use a “colored” PN. A colored PN supports a variety of different types or attributes through colored tokens. Colored tokens can be used to represent and identify different product attributes for a given order. For example, a colored token may include a vehicle model, a vehicle type, and an option package number. For simplicity, a colored token may also be referred to as a token. In exemplary embodiments, a token includes a hierarchical structure of attributes in a nested structure. For example, an order type token may be organized with exemplary values as: (Id=3, Configuration=(MerchModel=”Buick Regal LS“, Options=(“PowerSeats“, “Sunroof“)), DealerId=5, Tagged=True, OrderTime=“15:32,1.5.2001“). By using a colored PN to model a supply chain, a vast array of product configurations can be modeled.

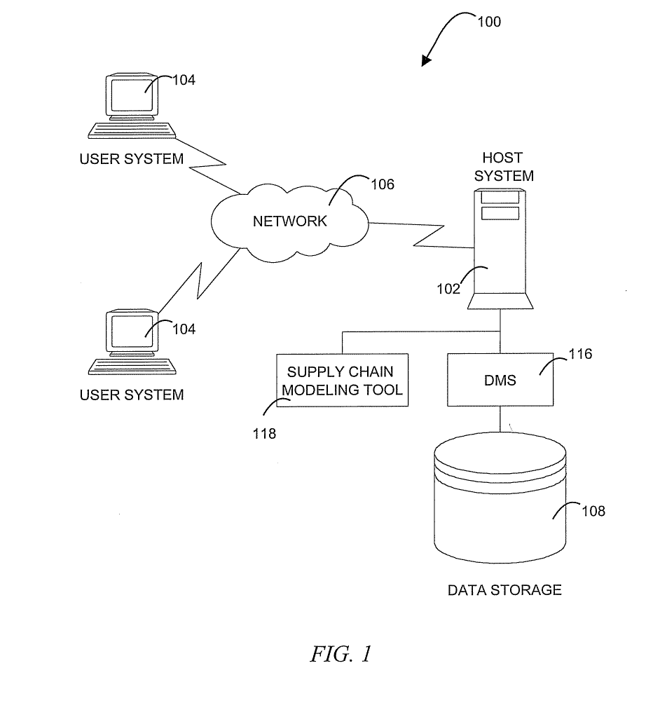

Turning now to the drawings, it will be seen that in FIG. 1 there is a block diagram of a system 100 upon which modeling of a supply chain is implemented in exemplary embodiments. The system 100 of FIG. 1 includes a host system 102 in communication with user systems 104 over a network 106. The host system 102 may be a high-speed processing device (e.g., a mainframe computer) that handles large volumes of processing requests from user systems 104. In exemplary embodiments, the host system 102 functions as an application server and a database management server. User systems 104 may comprise desktop or general-purpose computer devices that generate data and processing requests, such as updating supply chain data or requesting a supply chain simulation. While only a single host system 102 is shown in FIG. 1, it will be understood that multiple host systems may be implemented, each in communication with one another via direct coupling or via one or more networks. For example, multiple host systems may be interconnected through a distributed network architecture. The single host system 102 may also represent a cluster of hosts accessing a common data store, e.g., via a clustered file system that is backed by a data storage device 108.

The network 106 may be any type of communications network known in the art. For example, the network 106 may be an intranet, extranet, or an internetwork, such as the Internet, or a combination thereof. The network 106 may be a wireless or wireline network.

The data storage device 108 refers to any type of storage and may comprise one or more secondary storage elements, e.g., hard disk drive, tape, storage on a user system and a storage subsystem that is external to the host system 102. Types of data that may be stored in data storage device 108 include databases with tables or records of supply chain data and configuration information. It will be understood that the data storage device 108 shown in FIG. 1 is provided for purposes of simplification and ease of explanation and is not to be construed as limiting in scope. To the contrary, there may be multiple data storage devices utilized by the host system 102.

In exemplary embodiments, the host system 102 executes various applications, including a data management system (DMS) 116 and a supply chain modeling tool (SCMT) 118. Other applications, e.g., business applications, a web server, etc., may also be implemented by the host system 102 as dictated by the needs of the enterprise of the host system 102. The DMS 116 maintains one or more databases, controlling read and write accesses to the data storage device 108 in which databases are stored. All or a portion of the SCMT 118 and the DMS 116 may be located on a user system 104 with processing shared between the user system 104 and the host system 102. In addition, all or a portion of the data utilized by SCMT 118 and the DMS 116 may be located on the user system 104.

In exemplary embodiments, the user systems 104 access the host system 102 to request a simulation of a supply chain model. The user systems 104 may also access the host system 102 to enter new supply chain data, modify existing supply chain data, or update a supply chain model. In exemplary embodiments, the SCMT 118 is capable of generating and managing multiple supply chain models. The SCMT 118 may provide different views of each supply chain model depending upon permissions or security clearance for each user of the user systems 104. When the host system 102 receives a request to run a supply chain model simulation, the host system 102 may call the DMS 116 to retrieve supply chain data from tables or records stored in a database on data storage device 108. Alternatively, supply chain data may be accessed through a file system on the data storage device 108 or within the host system 102. Supply chain model structural information and associated configuration data may also be accessed through a file system on the data storage device 108 or within the host system 102. As described in greater detail herein, the SCMT 118 executes a supply chain model producing simulation and analysis results regarding the supply chain performance. The SCMT 118 may work in conjunction with the DMS 116 to manage storing and reporting of simulation and analysis results on the data storage device 108; although, it is understood that the SCMT 118 may be incorporated with the DMS 116 as a single entity.

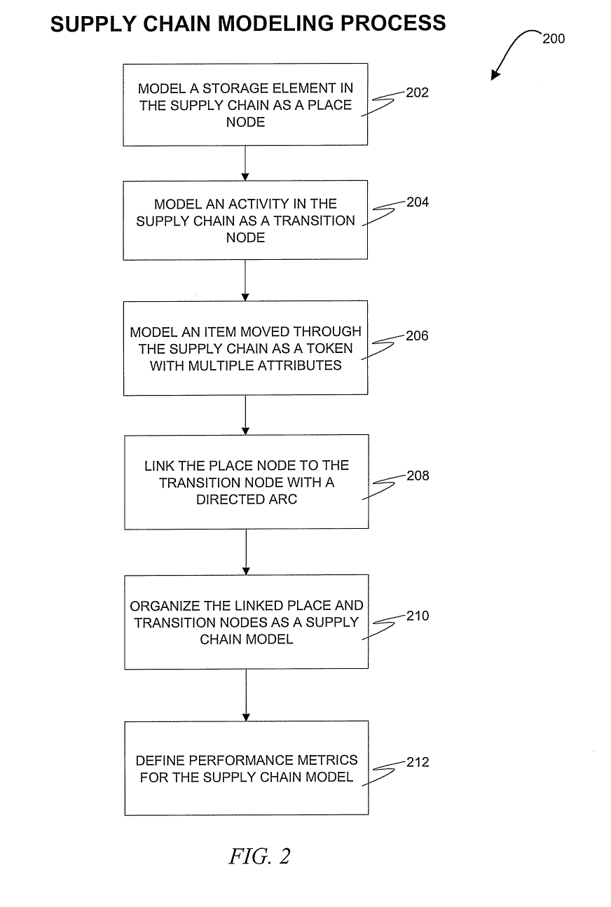

Referring now to FIG. 2, a process flow 200 for a supply chain modeling process is depicted for implementing exemplary embodiments of the invention. In exemplary embodiments, the SCMT 118 performs the process 200 on the host system 102. In alternate exemplary embodiments, the SCMT performs the process 200 on the user system 104. At block 202, a storage element (e.g., manufacturing plants, warehouses, dealers) in the supply chain is modeled as a place node. At block 204, an activity (e.g., production time, transport time, loading/unloading time) in the supply chain is modeled as a transition node. A transition node may be an immediate transition node, a timed transition node, or a substitution transition node, where a substitution transition node models a lower level sub-model in the vertical hierarchy of the supply chain. At block 206, an item, such as a vehicle, an order, or a part that moves through the supply chain is modeled as a token with multiple attributes (e.g., vehicle models, option types, part types). In exemplary embodiments, the token has a hierarchy of attributes.

Continuing with the process flow 200 depicted in FIG. 2, at block 208, linking is performed between the place node and the transition node with a directed arc. The directed arc indicates the direction of token movement between the place node and the transition node. At block 210, the linked place and transition nodes are organized as a supply chain model. The supply chain model may include a linked pair of place and transition nodes or any combination of place and transition nodes. At block 212, performance metrics for the supply chain model are defined. When the SCMT 118 runs the supply chain model, performance metrics are output to a graphical display or written to a file or database.

The SCMT 118 may also allow the user systems 104 to vary the level of analysis performed on the supply chain model based on the duration of a simulation or the level of detail included in the model. Organizing the supply chain model in a hierarchical structure provides flexibility for drilling down or digging deeper into the supply chain model. The capability to analyze data at a high level or at successively lower levels better enables managers and logistics specialists in managing members of the supply chain. For example, when a bottleneck appears in a particular business entity modeled in the supply chain with a sub-model, a user can further analyze elements of the sub-model to more accurately identify and isolate the bottleneck. A variety of performance metrics may assist a user in monitoring the model perfornance under simulation or operational conditions as further described herein.

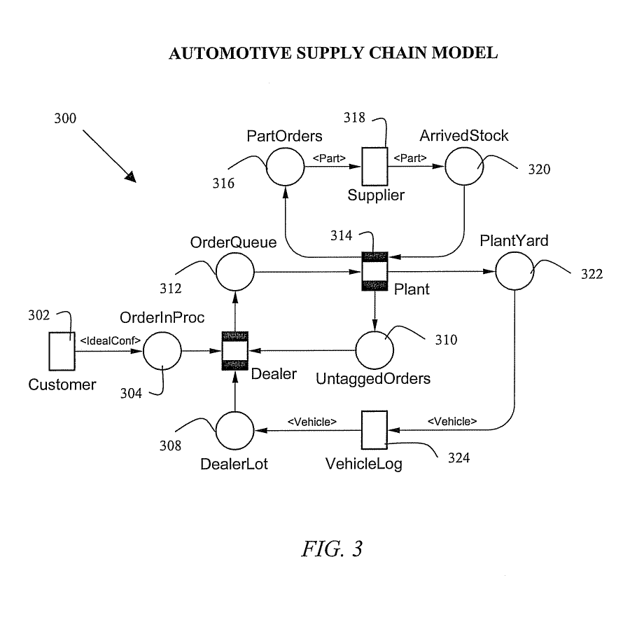

Turning now to FIG. 3, a block diagram of an automotive supply chain model 300 is depicted in accordance with exemplary embodiments. The block diagram 300 illustrates the top level of a hierarchically structured supply chain model network. The top level and each underlying level of the supply chain model enables simulation and aids decision makers who may focus upon different levels of the supply chain structure. The supply chain model 300 supports both vertical and horizontal hierarchical modeling structures. In exemplary embodiments, there are three vertical levels of the automotive supply chain model 300, including a strategic level, a tactical level, and an operational level. At the strategic level, the performance model may aggregately include all primary constituents of the supply chain, with greater detail of model elements defined in lower levels. For example, the plant transition node 314 can be regarded as a black box (i.e., a substitution transition node) at the strategic level that is modeled concretely in the lower levels. At the tactical level, the primary constituents, such as the plant transition node 314, are more explicitly modeled to provide guidance for tactical decision-making, including data such as monthly throughput of vehicle production. At the operational level, the performance model may involve accommodating fine details of the behavior of the supply chain model 300, such as daily sequencing and scheduling.

From the top-level strategic view of the automotive supply chain model 300 depicted in FIG. 3, the underlying tactical and operational levels are hidden. In exemplary embodiments, the hidden lower levels can be accessed through a graphical user interface (GUI). For example, a user system 104 may display the contents of the model 300 through an interactive GUI, which is produced when the SCMT 118 is executed upon the host system 102. By “clicking” on, or selecting, various elements of the model 300 visible through the interactive GUI, a user of a user system 104 may access and edit the lower levels of each model element, such as the plant transition node 314. Although the model 300 has a fixed number of hierarchical levels, it will be understood that the number of hierarchical levels of a model may vary according to the extent of the details of the model.

In exemplary embodiments, the SCMT 118 executes the model 300 in an operational scenario mode or a simulator mode. In the operational scenario mode, the SCMT 118 supports configuring and revising the model 300 in specific states to determine probable outcomes. In the simulator mode, the SCMT 118 accesses historical supply chain data through the DMS 116 to run the model 300 in a manner consistent with past supply chain performance. When the SCMT 118 runs the model 300, transactions between modeled business entities are monitored and results are reported. For example, the SCMT 118 tracks order creation within the model 300 from start to end, including time delays through each node of the model 300. The SCMT 118 may also support looping execution over a period of time or a single step mode to monitor incremental changes in the model 300. The SCMT 118 may also provide performance metrics, such as outputting the percentage of orders delivered on time. Other performance metrics may include, but are not limited to: lead-time, throughput rate, average machine utilization, expected number of parts in a buffer, and length of an order queue. The aforementioned performance metrics, as well as other performance metrics, may be derived from model simulation results to assist in improving a supply chain member's ability to provide reliable delivery, customer service, quality, rapid product introduction, and flexible capacity.

In exemplary embodiments, the model 300 begins execution with a customer order at customer transition node 302. The customer transition node 302 fires and a token is passed to the order in process place node 304. “IdealConf” describes the customer's desired vehicle configuration. The order in process place node 304 contains orders that are currently being processed by the dealer transition node 306. The dealer transition node 306 fires and consumes a token from the order in process place node 304. The dealer transition node 306 may also consume available tokens from dealer lot place node 308 and untagged orders place node 310. In exemplary embodiments, when the dealer place node 306 receives an order, the dealer attempts to fulfill the order through its available lot inventory or unassigned inventory, or the dealer passes the order request to a plant to produce the desired product.

In exemplary embodiments, the dealer transition node 306 requests that the plant produce the desired product through passing a token to order queue place node 312. A plant transition node 314 fires and consumes a token from the order queue place node 312. To build the desired product, the plant may need to order parts. The plant transition node 314 passes a token to a part orders place node 316. A supplier transition node 318 consumes a token from the part orders place node 316. When the supplier fulfills the part order, the supplier transition node 318 passes a token to arrived stock place node 320. The plant transition node 314 fires and consumes a token from the arrived stock place node 320. Once all parts are incorporated and the desired product is ready, the plant transition node 314 passes a token to the plant yard place node 322. The plant yard place node 322 passes a token to vehicle logistic network transition node 324. The vehicle logistic network transition node 324 transports manufactured vehicles to the lot of the appropriate dealer location. The vehicle logistic network transition node 324 fires and passes a token to the dealer lot place node 308, making inventory available to fulfill a customer order. While this example detailed a single vehicle order through an automotive supply chain model, it will be understood that there may be thousands of such vehicle orders transitioning through the model 300 at any given time. Furthermore, the complexity of the model may be expanded to include many dealers, plants, and customers, as well as other entities. In addition, the model may be applied to any supply chain and is not limited to an automotive manufacturer supply chain.

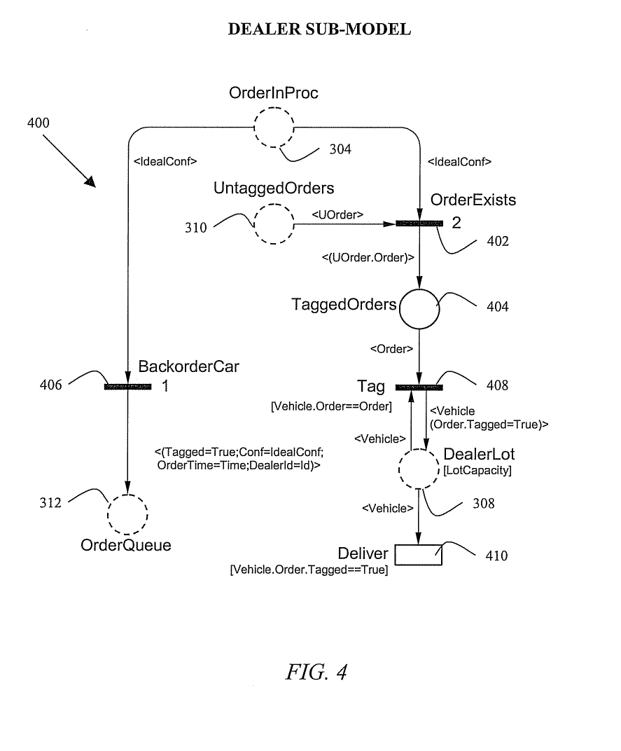

The dealer sub-model 400 of FIG. 4 illustrates a lower level in the hierarchy of the automotive supply chain model 300, further detailing the contents of the dealer transition node 306 through a substitution transition node. When a customer order token arrives in the order in process place node 304, there are two options within the dealer sub-model 400. If the desired vehicle configuration is available to the dealer, then order exists transition node 402 reserves the corresponding vehicle from the untagged orders place node 310 and passes a token to tagged orders place node 404. If no matching vehicles are available to the dealer, backorder car transition node 406 fires, and an order token is passed to the order queue place node 312, triggering a new vehicle order at the plant transition node 314. The attributes of the order token are set according to the customer demand as given by the configuration in “IdealConf”. In exemplary embodiments, the order time and the dealer number are also set, and the order is marked as being tagged for a customer. In the dealer sub-model 400, the order exists transition node 402 has a higher priority (2) than backorder car transition node 406, resulting in a new vehicle being produced if no matching order is available to the dealer.

Designated or tagged vehicles arrive in the dealer lot place 308 from the vehicle logistic network transition node 324. If an incoming vehicle corresponds to a tagged order at the dealer (i.e., the corresponding tagged order token is already in tagged orders place node 404) and thus tag transition node 408 guard function is true, the tag transition node 408 fires. Firing removes the corresponding order token from the tagged orders place node 404 and sets a tagging bit to true in the corresponding vehicle token in the dealer lot place node 308. The tagged vehicle is delivered to the customer by firing deliver transition node 410, if a guard function is true with respect to the tagging bit.

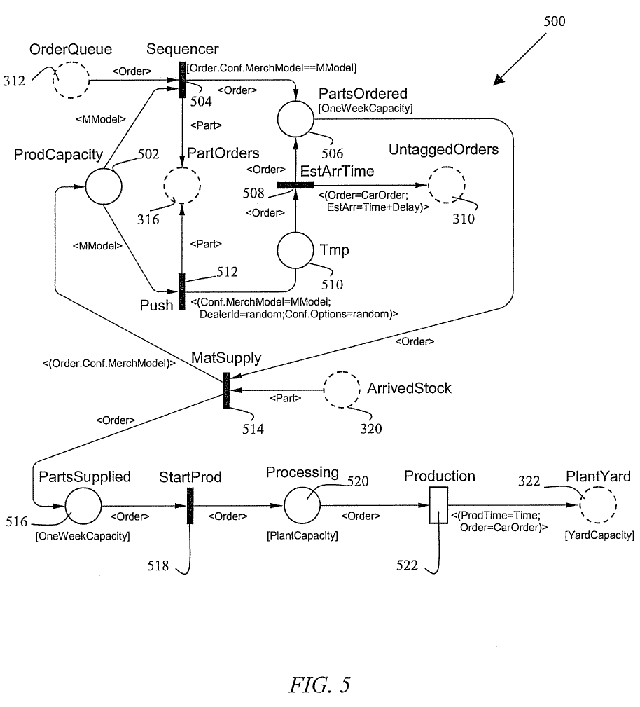

The plant sub-model 500 of FIG. 5 illustrates a lower level in the hierarchy of the automotive supply chain model 300, further detailing the contents of the plant transition node 314. In exemplary embodiments, a sequencer transition node 504 sets a schedule of production for the plant depending on current orders. A time guard function of the sequencer transition node 504 may be used to control the start of production and incorporate lead-time. The sequencer transition node 504 fires and consumes tokens from the order queue place node 312 and production capacity place node 502. The sequencer transition node 504 passes tokens to part orders place node 316 or parts ordered place node 506, depending on whether parts are available or must be ordered. The parts ordered place node 506 also receives tokens from estimated arrival time transition node 508. The estimated arrival time transition node 508 also passes tokens to the untagged orders place node 310 and consumes tokens from the temporary place node 510. The temporary place node 510 receives tokens from push transition node 512. The push transition node 512 also passes tokens to the part orders place node 316 and consumes tokens from the production capacity place node 502. The push transition node 512 order parts in an effort to utilize the available production capacity between orders, resulting in untagged orders. The production capacity place node 502 may hold tokens corresponding to merchandising models, which can be loaded from data stored in the data storage device 108 through the DMS 116.

The material supply transition node 514 consumes tokens from the parts ordered place node 506 and the arrived stock place node 320. The material supply transition node 514 passes tokens to either the production capacity place node 502 or parts supplied place node 516. The parts supplied place node 516 passes a token to start production transition node 518, and in turn, the start production transition node 518 fires and passes a token to processing place node 520. The processing place node 520 passes tokens to production transition node 522. In exemplary embodiments, the production transition node 522 is a timed transition that accounts for the time needed to produce a vehicle. Once a vehicle is produced, the production transition node 522 passes a token to the plant yard place node 322.

Embodiments of the invention may be embodied in the form of computer-implemented processes and systems for practicing those processes. The present invention may also be embodied in the form of a computer program product having computer program code containing instructions embodied in tangible media, such as floppy diskettes, CD-ROMs, hard drives, universal serial bus (USB) drives, or any other computer readable storage medium, such as read-only memory (ROM), random access memory (RAM), and erasable-programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes a system for practicing the invention. When implemented on a general-purpose microprocessor, the computer program code segments configure the microprocessor to create specific logic circuits. A technical effect of the executable instructions is to model a supply chain as a colored Petri net with multiple attributes and a hierarchical structure, and produce performance metrics for the model.

Technical benefits of embodiments of the invention may include: providing a graphical model of a supply chain to better visualize the elements and structure of the supply chain, providing performance metrics to support analysis and optimization, and providing a configurable environment to test hypothetical changes to the supply chain and support a variety of supply chain configurations.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

What is claimed is:

1. A method for modeling a supply chain, the method comprising:
modeling a storage element in the supply chain as a place node;
modeling an activity in the supply chain as a transition node, the transition node comprising at least one of:
an immediate transition node;
a timed transition node; and
a substitution transition node;
modeling an item moved through the supply chain as a token, the token comprising multiple attributes associated with the item;
linking the place node to the transition node with a directed arc, the directed arc indicating the direction of token movement between the place node and the transition node;
organizing the linked place and transition nodes as a supply chain model representing the flow of items through the supply chain; and
defining performance metrics for the supply chain model.

2. The method of claim 1, wherein the substitution transition node is a placeholder for a sub-model comprising:
a sub-model place node;
a sub-model transition node; and
a sub-model directed arc, the sub-model directed arc indicating the direction of token movement between the sub-model place node and the sub-model transition node.

3. The method of claim 2, wherein the sub-model transition node comprises at least one of:
an immediate transition node, a timed transition node, and a substitution transition node.

4. The method of claim 2, wherein the sub-model represents the flow of items through a business entity of the supply chain.

5. The method of claim 1, wherein the token further comprises a hierarchical structure of attributes.

6. The method of claim 1, wherein the token movement between the place node and the transition node comprises at least one of:
transferring a token;
copying a token;
creating a new token; and
setting a token attribute.

7. The method of claim 1, wherein the supply chain model incorporates historical supply chain data.

8. The method of claim 1, wherein the supply chain model comprises multiple business entities.

9. The method of claim 1, wherein the supply chain model is configurable to support multiple scenarios.

10. The method of claim 1, further comprising:
analyzing the performance metrics for the supply chain model.

11. The method of claim 1, wherein the performance metrics comprise at least one of:
a percentage of orders delivered on time;
a lead-time;
a throughput rate;
an average machine utilization;
an expected number of parts in a buffer; and
a length of an order queue.

12. The method of claim 1, wherein the supply chain model further comprises a vertical hierarchical structure comprising at least one of:
a strategic level;
a tactical level; and
an operational level.

13. A system for modeling a supply chain, the system comprising:
a host system with a processing circuit responsive to executable instructions which, when executed by the processing circuit facilitates:
modeling a storage element in the supply chain as a place node;
modeling an activity in the supply chain as a transition node, the transition node comprising at least one of:
an immediate transition node;
a timed transition node; and
a substitution transition node;
modeling an item moved through the supply chain as a token, the token comprising multiple attributes associated with the item;
linking the place node to the transition node with a directed arc, the directed arc indicating the direction of token movement between the place node and the transition node;
organizing the linked place and transition nodes as a supply chain model representing the flow of items through the supply chain; and
defining performance metrics for the supply chain model; and
a storage device for storing the supply chain model.

14. The system of claim 13, wherein the substitution transition node is a placeholder for a sub-model comprising:
a sub-model place node;
a sub-model transition node; and
a sub-model directed arc, the sub-model directed arc indicating the direction of token movement between the sub-model place node and the sub-model transition node.

15. The system of claim 13, wherein the token further comprises a hierarchical structure of attributes.

16. The system of claim 13, wherein the supply chain model incorporates historical supply chain data.

17. The system of claim 13, wherein the supply chain model comprises multiple business entities.

18. The system of claim 13, wherein the supply chain model is configurable to support multiple scenarios.

19. The system of claim 13, wherein the supply chain model further comprises a vertical hierarchical structure comprising at least one of:
a strategic level;
a tactical level; and
an operational level.

20. A computer program product for modeling a supply chain, the computer program product comprising:
a storage medium readable by a processing circuit and storing instructions for execution by the processing circuit for performing a method comprising:
modeling a storage element in the supply chain as a place node;
modeling an activity in the supply chain as a transition node, the transition node comprising at least one of:
an immediate transition node;
a timed transition node; and
a substitution transition node;
modeling an item moved through the supply chain as a token, the token comprising multiple attributes associated with the item;
linking the place node to the transition node with a directed arc, the directed arc indicating the direction of token movement between the place node and the transition node;
organizing the linked place and transition nodes as a supply chain model representing the flow of items through the supply chain; and
defining performance metrics for the supply chain model.
